(19) United States
(12) Patent Application Publication
(10) Pub. No.: US 2013/0082846 A1
(43) Pub. Date: Apr. 4, 2013

(54) SENSOR SYSTEM AND METHOD

(71) Applicants: Timothy Allen McKinley, Peoria, IL (US); Mark Steven Diekevers, Metamora, IL (US); John M. Plouzek, Peoria, IL (US); Mathew William Trone, Pekin, IL (US); Robert L. Meyer, Metamora, IL (US); Gregory W. Tomlins, Peoria, IL (US); Andrew Caruana, Burlington (CA)

(72) Inventors: Timothy Allen McKinley, Peoria, IL (US); Mark Steven Diekevers, Metamora, IL (US); John M. Plouzek, Peoria, IL (US); Mathew William Trone, Pekin, IL (US); Robert L. Meyer, Metamora, IL (US); Gregory W. Tomlins, Peoria, IL (US); Andrew Caruana, Burlington (CA)

(21) Appl. No.: 13/628,662

(22) Filed: Sep. 27, 2012

Related U.S. Application Data
(60) Provisional application No. 61/542,148, filed on Sep. 30, 2011.
(60) Provisional application No. 61/621,113, filed on Apr. 6, 2012.

(51) Int. Cl. G08C 19/16; B23P 11/00

(52) U.S. Cl. 340/870.01; 29/428

(57) ABSTRACT

A method is disclosed for collecting information related to a machine component of a mobile machine that is configured to perform work on a worksite. The sensor system may be installed on or within the machine component, and the machine component may be installed with the sensor system on the mobile machine. The information may be collected with the sensor system while the machine is performing work on the worksite, the information relating to a characteristic experienced by the machine component. The information may be transmitted with the sensor system. The sensor system may collect information related to a tracked undercarriage of the mobile machine, or the cutting head of a tunnel boring machine.

### CROSS-REFERENCE TO RELATED APPLICATION

This application claims priority to provisional application No. 61/542,148, filed on Sep. 30, 2011, and provisional application No. 61/621,113, filed on Apr. 6, 2012, each of which is incorporated herein by reference in its entirety.

### TECHNICAL FIELD

The current disclosure relates generally to a sensor system, and more particularly to a sensor system for collecting information related to a mobile machine.

### BACKGROUND

A mobile machine may be used to perform various types of work on different worksites, such as a construction site, a demolition site, a mining site, or a landfill site. For example, a bulldozer may be used to push soil and rock on a construction site. The bulldozer, as a track-type mobile machine, includes a tracked undercarriage with tracks on the left and right sides of the machine. Each of the tracks includes a chain formed by connecting a number of track links to one another, and connecting a number of track shoes to the chains. The tracks are supported by various roller assemblies on both sides of the machine.

Operation of the bulldozer inevitably results in wear or damage to various components, including components of the undercarriage such as the track links and the roller assemblies. It is known to service or replace a machine component, for example, when the component exceeds its expected lifetime (based on the age of the component or number of hours of use experienced by the component), or based on the results of inspection or evaluation of the component.

These known methods for determining when components are to be serviced or replaced suffer from numerous disadvantages. For example, a particular machine component may be capable of being used far in excess of its expected lifetime, and thus replacement of the component based solely on age may be premature and result in unnecessary costs and machine down-time. Conversely, a particular machine component may fail well in advance of its expected lifetime, and continued operation of the machine with the damaged component may result in damage to other components of the machine. Similarly, inspection and evaluation of a machine component may result in unnecessary costs and machine down-time when it is determined that service or replacement of the component is not required. Still further, inspection and evaluation may require that the machine be evaluated by temporarily installing various sensors throughout the machine, with extensive cabling connecting the sensor to a computer that collects data and other information from the sensors. The cabling prevents the machine from being operated on the worksite, and thus such evaluation does not provide information relating to the actual use of the machine while performing work.

Thus, there exists a need for an improved sensor system for collecting information related to a mobile machine. The sensor system and method in accordance with the current disclosure may overcome or avoid the above discussed or other disadvantages resulting from the use of known systems and methods.

### SUMMARY

The current disclosure may provide a method for collecting information related to a machine component of a mobile machine that is configured to perform work on a worksite. The sensor system may be installed on or within the machine component, and the machine component may be installed with the sensor system on the mobile machine. The information may be collected with the sensor system while the machine is performing work on the worksite, the information relating to a characteristic experienced by the machine component. The information may be transmitted with the sensor system.

The current disclosure may further provide a method for collecting information related to a machine component of an undercarriage of a mobile machine that is configured to perform work on a worksite, with a sensor system on or within the machine component. The information may be collected with the sensor system while the machine is performing work on the worksite, the information relating to at least one of wear, temperature, fluid level, fluid pressure, or load experienced by the machine component of the undercarriage. The collected information may be transmitted with the sensor system while the machine is performing work.

The current disclosure may still further provide a method for collecting information related to a machine component of a cutting head in a tunnel boring machine that is configured to bore a tunnel, with a sensor system on or within the machine component. The information may be collected with the sensor system while the machine is boring the tunnel, the information relating to at least one of wear, temperature, fluid level, fluid pressure, or load experienced by the machine component of the cutting head. The collected information may be transmitted with the sensor system while the machine is boring the tunnel.

### BRIEF DESCRIPTION OF THE DRAWINGS

FIG. 1 illustrates a block diagram of a sensor system, consistent with the disclosure;

FIG. 2 illustrates a pictorial isometric view of a bulldozer with which the sensor system of FIG. 1 may be used, consistent with the disclosure;

FIG. 3 illustrates a pictorial isometric view of a tunnel bore machine with which the sensor system of FIG. 1 may be used, consistent with the disclosure; and

FIG. 4 illustrates an exemplary method of using the sensor system of FIG. 1, consistent with the disclosure.

### DETAILED DESCRIPTION

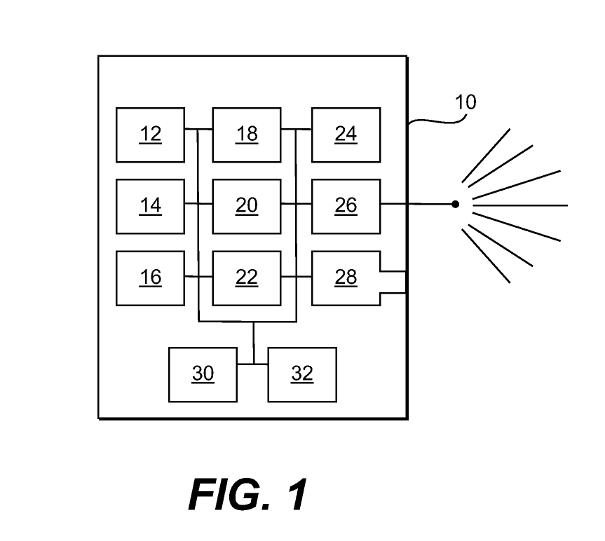

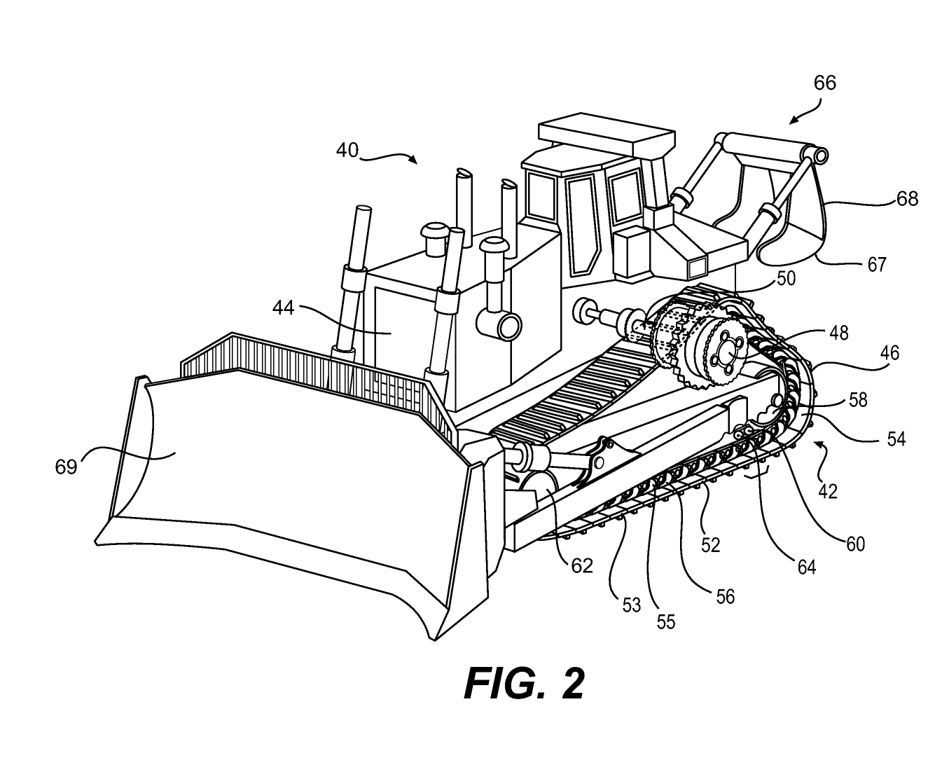

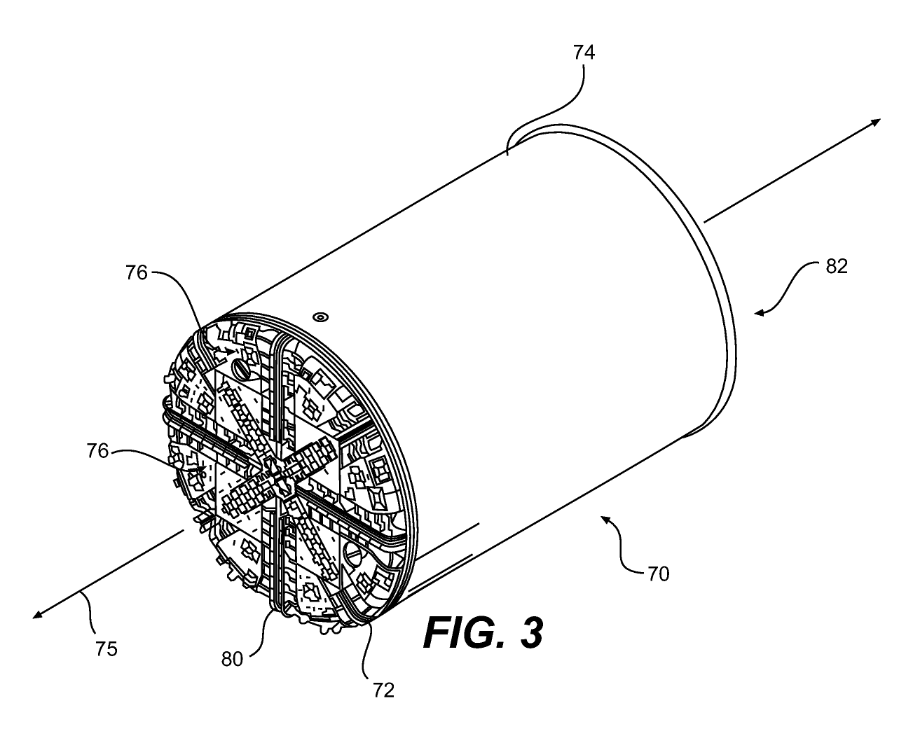

FIG. 1 is a block diagram of an exemplary embodiment of a sensor system 10, in accordance with the disclosure. Sensor system 10 may measure and/or receive data or other information, and/or may output data or other information related to a mobile machine on or within which sensor system 10 is installed. As discussed in further detail below, the measured, received, and/or outputted information may be related to one or more of a characteristic of the machine on or within which sensor system 10 is installed, a characteristic of a component of the machine, an operating condition of the machine, an environmental condition experienced by the machine, or any other information. For example, sensor system 10 may be used with a mobile machine such as a tractor (as shown in and described below with reference to a bulldozer shown in FIG. 2), a tunnel boring machine (as shown in and described below with reference to FIG. 3), or any other machine or structure. Sensor system 10 may be installed on or within (e.g., embedded within an interior) a component of the machine, such as during manufacture of the machine component, and information from sensor system 10 may be used to determine when the machine component and/or another machine component is to be repaired, serviced, or replaced. Alternately or additionally, the information from sensor system 10 also may be used to control operation of the machine. Control of the mobile machine may include adjustment of the machine component that includes sensor system 10, adjustment of another machine component, or autonomous control of the mobile machine. When the machine component is replaced, the replacement component also may include another sensor system 10 installed within or on the component.

As shown in FIG. 1, sensor system 10 may include one or more tangible, non-transitory hardware components, including one or more central processing units (CPUs) or processors. For example, a sensing component 12 may be used to directly and/or indirectly measure, sense, and/or otherwise receive information as an input. A signal conditioner 14 may condition a signal received from sensing component 12, such that the signal may be used by one or more components of sensor system 10. An amplifier 16 may amplify one or more signals for further use by one or more components of sensor system 10. A multiplexer 18 may multiplex one or more signals for further use by one or more components of sensor system 10. A converter 20, such as either or both of an analog-to-digital (A/D) converter and a digital-to-analog (D/A) converter, may convert one or more signals for further use by one or more components of sensor system 10.

A controller 22, such as a low-power microcontroller, may provide an output in response to the input received from sensing component 12 and/or one or more signals processed by any or all of signal conditioner 14, amplifier 16, multiplexer 18, and converter 20. An on-board memory 24, such as either or both of a random-access memory (RAM) and a read-only memory (ROM), may store information related to one or more of the input received from sensing component 12, one or more processed signals from signal conditioner 14, amplifier 16, multiplexer 18, and/or converter 20, and the output from controller 22. Alternately or additionally, on-board memory 24 may store instructions used by one or more other components of sensor system 10, such as controller 22.

A transceiver 26, such as for example a radio-frequency (RF) transceiver, may wirelessly broadcast the output provided by controller 22, such as at a frequency of 2.4 GHz, 900 MHz, or another frequency. Alternately or additionally, an output port 28, such as for example a USB (universal serial bus) port or similar port, may transmit the output provided by controller 22 through a cable or other connection removably connected to output port 28. A battery 30, such as for example a lithium-ion (Li-ion) battery, may power one or more of the components of sensor system 10. Alternately or in addition to battery 30, an energy source 32, such as a vibration-based energy-harvesting system, may power one or more of the components of sensor system 10, and/or may be used to charge battery 30. Any or all of these components may be located in a sealed housing that sufficiently protects the components from damage due to heat, cold, vibration, weather, exposure to liquids, worksite conditions, and/or any other conditions that may damage the components of the sensor system 10.

Although FIG. 1 shows examples of specific components used in sensor system 10, sensor system 10 is not limited to the particular configuration shown in the drawing. Rather, consistent with the disclosure, sensor system 10 may include other components, more components, or fewer components than those described above. Further, it is contemplated that one or more of the hardware components listed above may be implemented in part or wholly using software. One or more of such software components may be stored on a tangible, non-transitory computer-readable storage medium that includes computer-executable instructions that, when executed by a processor or other computer hardware, perform methods and processes consistent with the disclosure.

FIG. 2 illustrates a particular, non-limiting embodiment of a tractor using sensor system 10. Specifically, the figure shows bulldozer 40 as an example of a mobile machine with which the above-described sensor system 10 may be used. Although FIG. 2 shows a bulldozer, sensor system 10 may be used with any other type of tracked or wheeled mobile machine, such as a tractor, a loader, an excavator, or any other machine that performs an operation associated with an industry such as mining, construction, demolition, landfill, farming, or any other industry.

Bulldozer 40 may include a tracked undercarriage 42 that is driven by a power source 44. Specifically, power source 44 may drive tracked undercarriage 42 at a range of output speeds and/or torques. Power source 44 may be an engine, such as for example a diesel engine, a gasoline engine, a gaseous fuel-powered engine, or any other suitable engine. Power source 44 may also be a non-combustion source of power, such as for example a fuel cell, a power storage device, or any other source of power known in the art.

Tracked undercarriage 42 may include tracks 46 (only one shown in FIG. 2) on left and right sides of thereof, which are driven by power source 44 via sprockets 48 also on left and right sides thereof. Specifically, each sprocket 48 may be driven by a final drive axle 50 that is, in turn, driven by power source 44. Each track 46 may include a chain 52 to which track shoes 53 are attached. Each chain 52 may include a plurality of chain link assemblies 54 made up of track links 55 connected to each other by rod assemblies 56. Sprockets 48 may engage and transmit a torque to rod assemblies 56 to thereby move chains 52 about idler assemblies 58 and roller assemblies 60. Each idler assembly 58 may include an idler wheel 62 that rotates on an idler shaft (not shown). Each roller assembly 60 may includes a roller rim 64 that rotates on a roller shaft (not shown). Generally, two idler assemblies 58 and between four and eight roller assemblies 60 may be used on each side of bulldozer 40. However, a different number of idler assemblies 58 and/or roller assemblies 60 may be used on one or both sides of bulldozer 40. In accordance with the disclosure, other roller assemblies (not shown) may be used with or in place of either or both of idler assemblies 58 and roller assemblies 60.

As shown in FIG. 2, bulldozer 40 may include a ground engaging tool 66 connected to a back end of the machine. Ground engaging tool 66 may be, for example, a ripper that is configured to break up a ground surface, rock, or other materials on the worksite. The ripper may include a replaceable ripper tip 67 that is removably disposed in a ripper shank 68. Although FIG. 2 shows an example of a particular ground engaging tool, bulldozer 40 is not limited to using only a ripper. Instead, bulldozer 40 may use a different type of ground engaging tool. Also consistent with the disclosure, bulldozer 40 may omit the use of ground engaging tool 66 entirely.

As shown in FIG. 2, bulldozer 40 may include a blade 69 connected to a front end of the machine. Blade 69 may be used to push, move, pickup, carry, or otherwise perform work on soil, rock, or debris, for example, on the worksite. Although FIG. 2 shows an example of a particular blade 69, bulldozer 40 is not limited to using this specific blade. Instead, bulldozer 40 may include a different type of blade. Also consistent with the disclosure, bulldozer 40 may omit the use of blade 69 entirely. Details related to the use of sensor system 10 with bulldozer 40 that may include ground engaging tool 66 and/or blade 69, among other components, are discussed in the following section.

FIG. 3 illustrates a tunnel boring machine 70 as another specific example of a mobile machine in which the above-described sensor system 10 may be used. Sensor system 10 is not limited to being used with the particular boring machine shown in FIG. 3, but instead may be used with any boring machine that cuts through or otherwise removes soil, rock, and/or other materials, for example.

As shown in FIG. 3, tunnel boring machine 70 may include a cutting head 72 configured to cut through soil, rock, and other materials during boring of a tunnel into the earth. Cutting head 72 may be mounted on a first end of a cylindrical body 74 that includes a longitudinal axis 75. During boring of a tunnel, cutting head 72 may rotate about longitudinal axis 75 of cylindrical body 74, while cylindrical body 74 does not rotate.

Cutting head 72 may include a plurality of cutters 76 (e.g., drag cutters and/or roller cutters, broadly referred to as rock cutters) that are configured to cut through and otherwise loosen any or all of soil, rock, gravel, or other materials. Cutting head 72 may also include a plurality of intake ports 80 disposed between or among rock cutters 76. Each intake port 80 may be in communication with a hollow interior portion of cylindrical body 74. Various material moving mechanisms, such as conveyors and mixers (not shown), may be disposed within the hollow interior portion of cylindrical body 74.

By this arrangement, soil, rock, and other materials may first be cut, loosened, or otherwise removed from a tunnel being formed in the earth by tunnel boring machine 70, by the rotation of cutting head 72 relative to cylindrical body 74. The cut and loosened material from the tunnel may be received, though intake ports 80, into the hollow interior portion of cylindrical body 74. The material may be conveyed through the hollow interior portion and then out of a back end 82 of tunnel boring machine 70. A propulsion mechanism (not shown) may be used to propel tunnel boring machine 70 through the earth as the material is removed from the tunnel by cutting head 72. Details related to the use of sensor system 10 with tunnel boring machine 70 that may include cutting head 72, among other components, are discussed below.

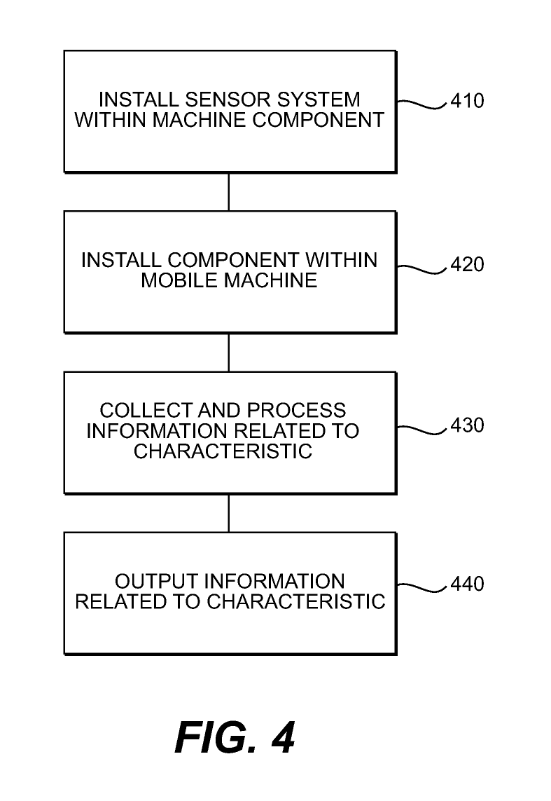

Thus, the foregoing description describes an exemplary configuration of sensor system 10, as well as examples of particular mobile machines (e.g., bulldozer 40 and tunnel boring machine 70) with which sensor system 10 may be used. However, sensor system 10 is not limited to use in these specific mobile machines, but instead may be used with other various machines or structures, in accordance with the below discussion. Further details of a method of using sensor system 10 are discussed in the following section, with reference to FIG. 4.

### INDUSTRIAL APPLICABILITY

In accordance with the disclosure, the above-described sensor system 10 may measure and/or receive data or other information, and/or may output data or other information, related to a machine with which sensor system 10 is used, including a mobile machine such as bulldozer 40 or tunnel boring machine 70. Described below are specific examples of characteristics, including wear, temperature, fluid level, fluid pressure, and load, which may be measured by sensor system 10. Also described below with reference to FIG. 4 is a particular exemplary method of using sensor system 10. Sensor system 10 is not limited to these specific examples, however.

In accordance with the disclosure, sensor system 10 may be used to measure wear (e.g., including but not being limited to a change in a physical size or shape of a component which is caused by use and/or contact with one or more other components). By way of non-limiting example, sensor system 10 may measure wear of a component within a tracked or wheeled undercarriage of a mobile machine, such as a track link, a track shoe, a component of a roller assembly, a component of an idler assembly, a sprocket, a bushing, any other roller, and combinations of these or other components. Consistent with the disclosure, sensor system 10 may measure wear of a component of a ground engaging tool, such as: a tip, an adapter, an edge, a base edge, a sidecutter, or any other component of a bucket; a tip, a plate, an end bit, or any other component of a compactor; a ripper tip; a cutting edge; a wear bar; a wear plate; and combinations of these or other components. Also consistent with the disclosure, sensor system 10 may be used to measure wear of a component of a tunnel boring machine, such as a rock cutter, other components of a cutting head, or combinations of these or other components. Sensor system 10 is not limited to measuring wear of only these systems and components, however, but instead may be used to measure wear of any component of the above-discussed systems, or different components of other systems.

When sensor system 10 is used to measure wear, a component of sensor system 10, such as sensing component 12, may be placed in a location where wear is to be measured. For example, sensing component 12 may be located on a specific portion of a surface of a machine component, so that as the surface of the machine component is worn, sensing component 12 simultaneously experiences a corresponding amount of wear. A characteristic or an output of sensing component 12 may change as sensing component 12 wears. In accordance with the disclosure, a circuit might be opened or closed when a component (a wire, a capacitor, a resistor, a diode, a transistor, or another component) of sensing component 12 is worn beyond a threshold amount, or an electric characteristic of sensing component 12 may progressively change based on and in relation to an amount of wear experienced by sensing component 12. The above-discussed components of sensor system 10, such as signal conditioner 14, amplifier 16, multiplexer 18, and converter 20, may be used to process the signal received from sensing component 12 and/or one or more signals received from one another.

Controller 22 may provide an output in response to the input received from sensing component 12 and/or signals from processing by one or more of signal conditioner 14, amplifier 16, multiplexer 18, and converter 20. Memory 24 may store information related to one or more of the input received from sensing component 12, processed signals from one or more of signal conditioner 14, amplifier 16, multiplexer 18, and converter 20, and the output from controller 22. Transceiver 26 and/or output port 28 may transmit the output provided by controller 22. Battery 30 and/or energy source 32 may power one or more of the components of sensor system 10. The output of controller 22 may be received by one or more components on-board the mobile machine, such as a processor or other computer system, to provide an alert so that an operator on the machine may take corrective or other action (including servicing, repair, or replacement of the machine component including sensor system 10 and/or another component), so that automatic adjustment of the machine component including sensor system 10 and/or another machine component may occur, and/or so that the mobile machine may be autonomously controlled. Alternately or additionally, the output of controller 22 may be received by one or more components, such as a processor or other computer system, off-board the machine.

Also in accordance with the disclosure, sensor system 10 may be used to measure temperature. By way of non-limiting example, sensor system 10 may measure temperature of or within a component in a tracked or wheeled undercarriage of a mobile machine, such as a component of a roller assembly, a component of an idler assembly, a bushing, any other roller, and combinations of these or other components. Consistent with the disclosure, sensor system 10 may be used to measure temperature of or within a component of a tunnel boring machine, such as a rock cutter, other components of a cutting head, or any other component. Sensor system 10 is not limited to measuring temperature of only these systems and components, but instead may be used to measure temperature of any components of the above-discussed systems, or different components of other systems.

A component of sensor system 10, such as sensing component 12, may be used to measure temperature. For example, sensing component 12 may include a thermocouple. Sensing component 12 may or may not be submerged in a fluid, such as a lubricant (e.g. oil), within an interior of a component of the machine. The above-discussed components of sensor system 10 may then process one or more signals, and transmit an output from controller 22, such as by using transceiver 26 and/or output port 28. The output may be received by a component on-board the machine and/or a component off-board the machine.

Still further in accordance with the disclosure, sensor system 10 may be used to measure fluid level or pressure. By way of non-limiting example, sensor system 10 may measure a level or a pressure of fluid within a component in a tracked or wheeled undercarriage of a mobile machine, such as one or more hydraulic systems associated with any of a roller assembly, an idler assembly, any other roller assembly, and combinations of these or other components. Consistent with the disclosure, sensor system 10 may be used to measure fluid level or pressure within a component of a tunnel boring machine, such as one or more hydraulic systems associated with a rock cutter, other components of one or more hydraulic systems associated with a cutting head or any other component. Sensor system 10 is not limited to measuring a level or a pressure of fluid within only these systems and components, but instead may be used to measure fluid level or pressure within any components of the above-discussed systems, or different components of other systems.

A component of sensor system 10, such as sensing component 12, may be used to measure the fluid level or pressure. Sensing component 12 may or may not be submerged in a fluid, such as a lubricant (e.g. oil), within an interior of a component of the machine. For example, sensing component 12 may include an optical sensor that optically detects the level of fluid. Alternately or additionally, sensing component 12 may include a pressure sensor that measures the pressure of the fluid within the interior of the component. The above-discussed components of sensor system 10 may then process one or more signals, and transmit an output from controller 22, such as by using transceiver 26 and/or output port 28. The output may be received by a component on-board the machine and/or a component off-board the machine.

Still further in accordance with the disclosure, sensor system 10 may be used to measure load. By way of non-limiting example, sensor system 10 may measure load on a component within a tracked or wheeled undercarriage of a mobile machine, such as a track link, a track shoe, a component of a roller assembly, a component of an idler assembly, a sprocket, a bushing, any other roller, and combinations of these or other components. Consistent with the disclosure, sensor system 10 may measure load on a component of a ground engaging tool, such as: a tip, an adapter, an edge, a base edge, a sidecutter, or any other component of a bucket; a tip, a plate, an end bit, or any other component of a compactor; a ripper tip; a cutting edge; a wear bar; a wear plate; and combinations of these or other components. Also consistent with the disclosure, sensor system 10 may be used to measure load on a component of a tunnel boring machine, such as a rock cutter, other components of a cutting head, or combinations of these or other components. Sensor system 10 is not limited to measuring load on only these systems and components, however, but instead may be used to measure load on any component of the above-discussed systems, or different components of other systems.

When sensor system 10 is used to measure load, a component of sensor system 10, such as sensing component 12, may be placed in a location where load is to be measured. For example, sensing component 12 may be one or more strain gages. The above-discussed components of sensor system 10 may then process one or more signals, and transmit an output from controller 22, such as by using transceiver 26 and/or output port 28. The output may be received by a component on-board the machine and/or a component off-board the machine.

FIG. 4 illustrates an exemplary method of using sensor system 10 that is configured to measure or otherwise collect information relating to one or more of the above-discussed characteristics experienced by a machine component. As shown in FIG. 4, in Step 410 sensor system 10 may be installed on or within on a component of a mobile machine, such as bulldozer 40, tunnel boring machine 70, or any other machine. The location and way in which sensor system 10 is installed may be related to the characteristic or characteristics to be measured by sensor system 10. For example, when sensor system 10 is to measure load on a track link, sensor system 10 may be installed directly on or within an interior of the track link. In accordance with the disclosure, sensor system 10 may be installed during manufacture of the machine component, and may be installed in such as way as to impede or prevent removal, replacement, or servicing of sensor system 10, such that the machine component and sensor system 10 may be provided as a single unit. As further shown in FIG. 4, in Step 420 the machine component with sensor system 10 may be installed on the mobile machine. Installation of the machine component may require no additional steps, tooling, or processes as compared to a machine component that does not include sensor system 10. As discussed above with respect to FIG. 2, the particular machine component may be for use in a bulldozer, such as a component of the tracked undercarriage. Also as discussed above with respect to FIG. 3, the particular component may be for use in a tunnel boring machine, such as a component of the cutting head. However, in accordance with the disclosure, the machine component of Step 410 is not limited to components for use in these specific machines, and thus the machine of Step 420 is similarly not limited to being a bulldozer or tunnel boring machine.

As shown in FIG. 4, in Step 430 sensor system 10 may collect and process data or other information related to the measured characteristic (e.g., wear, temperature, fluid level, fluid pressure, or load), as experienced by the machine component. This information may be collected during operation of the machine on the worksite, and thus may reflect actual conditions experienced by the machine component while the machine is performing work. In accordance with the disclosure, sensor system 10 may include a particular sensing component 12 configured to receive information related to the particular characteristic to be measured. For example, when sensor system 10 is to measure load experienced by a track link, sensing component 12 may include one or more strain gages. As discussed above, components of sensor system 10, such as signal conditioner 14, amplifier 16, multiplexer 18, and converter 20, may be used to process the signals received from sensing component 12 and/or from one another. Controller 22 may determine an output in response to the input received from sensing component 12 and/or signals received from one or more of signal conditioner 14, amplifier 16, multiplexer 18, and converter 20. Memory 24 may store information related to one or more of the input received from sensing component 12, signals from one or more of signal conditioner 14, amplifier 16, multiplexer 18, and converter 20, and the output from controller 22.

As shown in FIG. 4, in Step 440 sensor system 10 may output information related to the measured characteristic. For example, when sensor system 10 collects information related to load experienced by a track link, the output determined by controller 22 may be indicative of that load. Transceiver 26 and/or output port 28 may transmit the output provided by controller 22. The output may be received by a component on-board the machine and/or by a component off-board the machine. For example, the output may be used by the on-board and/or off-board component to provide an alert so that an operator on the machine or another entity may take corrective or other action, so that automatic adjustment of the machine component including sensor system 10 and/or another machine component may occur, and/or so that the mobile machine may be autonomously controlled.

In accordance with the disclosure, a single sensor system 10 may measure a plurality of the above-discussed characteristics (e.g., may measure at least two of wear, temperature, fluid level, fluid pressure, or load), and/or may measure other characteristics. Alternately or additionally, a mobile machine or other structure may include multiple sensor systems 10, each measuring one or more of the above characteristics and/or other characteristics. Thus, although the foregoing description provides specific examples, sensor system 10 is not limited to the particular uses described above. Rather, sensor system 10 may measure any characteristic of a machine on and/or within which it is installed, characteristic of a component of the machine, operating condition of the machine, environmental condition, ambient condition, or any other information. By way of non-limiting examples, sensor system 10 may measure or determine stress, relative distance between components, velocity, angular velocity, acceleration, angular acceleration, position, bolt clamp load, joint clamp load, crack initiation, crack propagation, torque, whether a part is attached properly, whether a part is attached tightly, whether a part is loose, whether a part is missing, whether a part is rotating, or whether a part is not rotating, among others.

The output of sensor system 10 may be used in a number of different ways. By way of non-limiting examples, the output may be used to evaluate a structural life of a machine component, evaluate a wear life of a component, provide an alert of impending component failure, provide an alert of desired or required component maintenance or replacement, control machine power to mitigate component failure or wear, autonomously control operation of an implement of the machine to prevent component failure or wear, provide an alert of desired or required track tension adjustment, provide an alert of abnormal component wear, and/or autonomously control operation of the machine. Further, the output may be used by various entities. By way of non-limiting example, the output may be used by an operator of the machine, a foreperson of the worksite, a repair person, and/or a customer. Thus, benefits provided by using sensor system 10 may include improved machine life, improved machine performance, improved machine maintenance scheduling, improved tracking of the machine by equipment maintenance manager, improved component life, improved component performance, enhanced machine resale value, and/or improved product design and validation.

Of course, sensor system 10 is not limited to the particular machines or examples described above, but instead may be used with any machine, such as a machine having any type of ground engaging tool. For example, the machine may be a hydraulic front shovel, cable (rope) shovel, backhoe, mass excavator, hydraulic excavator, dragline, wheel loader, track-type loader, or any other machine.

It will be apparent to those skilled in the art that various modifications and variations may be made to the disclosed sensor system. Other embodiments of the described sensor system will be apparent to those skilled in the art from consideration of the specification and practice of the assembly and method disclosed herein. It is intended that the specification and examples be considered as non-limiting.

What is claimed is:

1. A method for collecting information related to a machine component of a mobile machine that is configured to perform work on a worksite, the method comprising:
installing a sensor system on or within the machine component;
installing the machine component with the sensor system on the mobile machine;
collecting the information with the sensor system while the machine is performing work on the worksite, the information relating to a characteristic experienced by the machine component; and
transmitting the information with the sensor system.

2. The method of claim 1, wherein the characteristic is at least one of wear, temperature, fluid level, fluid pressure, or load experienced by the machine component.

3. The method of claim 2, wherein transmitting includes wirelessly transmitting the information.

4. The method of claim 3, wherein the sensor system includes a sensing component, and the sensing component is configured to collect the information related to at least one of wear, temperature, fluid level, fluid pressure, or load experienced by the machine component.

5. The method of claim 4, wherein the sensing component is configured to collect the information related to at least two of wear, temperature, fluid level, fluid pressure, or load experienced by the machine component.

6. The method of claim 4, wherein the sensor system includes a second sensing component configured to collect the information related to at least one of wear, temperature, fluid level, fluid pressure, or load experienced by the machine component.

7. The method of claim 2, wherein installing the machine component includes installing the machine component in a tracked undercarriage of the mobile machine.

8. The method of claim 2, wherein installing the machine component includes installing the machine component in a cutting head of a tunnel boring machine.

9. A method for collecting information related to a machine component of an undercarriage of a mobile machine that is configured to perform work on a worksite, with a sensor system on or within the machine component, the method comprising:
collecting the information with the sensor system while the machine is performing work on the worksite, the information relating to at least one of wear, temperature, fluid level, fluid pressure, or load experienced by the machine component of the undercarriage; and
transmitting the collected information with the sensor system while the machine is performing work.

10. The method of claim 9, further including:
controlling operation of the mobile machine, based on the transmitted information, by at least one of adjusting the machine component, adjusting another component of the mobile machine, or autonomously controlling operation of the mobile machine.

11. The method of claim 9, wherein transmitting includes wirelessly transmitting the collected information.

12. The method of claim 9, wherein the sensor system includes a sensing component, and the sensing component is configured to collect the information related to at least one of wear, temperature, fluid level, fluid pressure, or load experienced by the machine component.

13. The method of claim 12, wherein the sensing component is configured to collect the information related to at least two of wear, temperature, fluid level, fluid pressure, or load experienced by the machine component.

14. The method of claim 12, wherein the sensor system includes a second sensing component configured to collect the information related to at least one of wear, temperature, fluid level, fluid pressure, or load experienced by the machine component.

15. The method of claim 9, wherein the undercarriage is a tracked undercarriage including first and second tracks on left and right sides of the undercarriage.

16. A method for collecting information related to a machine component of a cutting head in a tunnel boring machine that is configured to bore a tunnel, with a sensor system on or within the machine component, the method comprising:
collecting the information with the sensor system while the machine is boring the tunnel, the information relating to at least one of wear, temperature, fluid level, fluid pressure, or load experienced by the machine component of the cutting head; and
transmitting the collected information with the sensor system while the machine is boring the tunnel.

17. The method of claim 16, wherein the machine component is a rock cutter.

18. The method of claim 16, wherein the sensor system includes a sensing component, and the sensing component is configured to collect the information related to at least one of wear, temperature, fluid level, fluid pressure, or load experienced by the machine component.

19. The method of claim 18, wherein the sensing component is configured to collect the information related to at least two of wear, temperature, fluid level, fluid pressure, or load experienced by the machine component.

20. The method of claim 18, wherein the sensor system includes a second sensing component configured to collect the information related to at least one of wear, temperature, fluid level, fluid pressure, or load experienced by the machine component.
